(19) United States
(12) Patent Application Publication
(10) Pub. No.: US 2025/0259095 A1
(43) Pub. Date: Aug. 14, 2025

(54) Fine-Grained Selective Quantization to Maximize Hardware Resource Utilization

(71) Applicant: Microsoft Technology Licensing, LLC, Redmond, WA (US)

(72) Inventors: Vedula Venkata Srikant BHARADWAJ, Bellevue, WA (US); Victor Jonas RUEHLE, Cambridge (GB); Jorge Alexandre SILVA TAVARES, Munich (DE); Upasana SRIDHAR, Pittsburgh, PA (US)

(21) Appl. No.: 18/437,028

(22) Filed: Feb. 8, 2024

(51) Int. Cl. G06N 20/00

(52) U.S. Cl. CPC G06N 20/00

(57) ABSTRACT

Techniques for performing fine-grained mixed precision quantization for an ML model are disclosed. A quantizable operation is identified. This quantizable operation is partitioned into multiple sub-operations having multiple different precision data formats. One or more kernels are generated. These kernel(s) are tasked with simultaneously executing the sub-operations. Consequently, the first sub-operation, which has the first precision data format, is executed simultaneously with the second sub-operation, which has the second, different precision data format.

### BACKGROUND

Hardware accelerators, such as graphics processing units (GPUs), have revolutionized artificial intelligence (AI) acceleration by leveraging their parallel processing capabilities to handle the immense computational demands of machine learning (ML) algorithms, especially for training and inference. The performance of machine learning execution on such hardware is intricately tied to the available hardware resources on the device, such as the register file, the scratch pad space, the arithmetic logic unit (ALU), the compute capability, and the memory bandwidth. These hardware constraints can collectively influence the throughput and latency of AI operations.

The register file, which is a limited and fast-access memory within the GPU, dictates the number of variables that can be stored simultaneously during computation. Consequently, the register file impacts the size of operation that can be simultaneously computed.

The scratch pad space, which is a smaller but faster memory pool than global memory, impacts the storage and access of intermediate results. Consequently, the scratch pad space influences the ML algorithm's overall execution speed.

The ALU compute units, which typically have multiple instances, determine the number of arithmetic and logical operations that can be performed concurrently. The ALU influences the GPU's ability to process parallelized neural network layers effectively.

The memory bandwidth governs the rate at which data can be read from and written to the GPU memory. Memory bandwidth directly impacts the throughput of AI computations.

The interplay of these hardware resources underscores the delicate balance required for optimizing AI inference execution performance on GPUs. Strategies to maximize and utilize these resources efficiently are highly desirable to unlock the full performance potential of AI-accelerated computing.

The execution of fundamental operations in machine learning (e.g., matrix multiplication (matmul), convolution, etc.) are implemented by tiling chunks of work to be done by each core or set of cores in hardware. This is done to parallelize the overall computational workload across the parallel processing capability of the hardware. The tiles utilize the hardware resources to perform the computation by storing data in the registers, the scratch pad, and so on, and utilize the respective ALU units to perform the computations.

Modern ML hardware accelerators support computation of lower precision data (FP8, INT8, INT4) through dedicated hardware ALU pipelines and other units in addition to the traditional high-precision floating point hardware pipelines (FP32). The latency of computation on these low-precision hardware ALU units is much lower owing to the lesser hardware complexity units, and the values stored in these lower-precision formats consume less memory space. Several machine learning models are thus deployed after performing mixed-precision quantization for achieving target latencies as well as improving the throughput (e.g., inference per second) of the inferencing system.

In such mixed-precision models, weights and parameters of one or more operations are quantized to lower-precision formats, such as INT8. Such models are generally compiled through a quantization tool that converts the FP32 weights and parameters of certain eligible operations, and then the compiler crafts INT8 kernels for execution on hardware. While advancements in improving the utilization of hardware resources when performing ML operations have been ongoing, there is still a need to further improve the utilization of hardware when performing ML operations.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to systems, hardware storage devices, and methods for facilitating execution of a machine learning (ML) operation by determining that the ML operation is partitionable into multiple sub-operations having different operational requirements, which include one or more of an accuracy requirement, a latency requirement, or a throughput requirement for an ML model executing the ML operation, and by executing the multiple sub-operations using different data precision representations to satisfy the different operational requirements while also satisfying a predetermined hardware utilization threshold, said method including: identifying an ML operation that is executable using a set of hardware resources; quantizing the ML operation by: evaluating the ML operation to determine that the ML operation is partitionable into at least a first sub-operation and a second sub-operation, wherein the ML operation is determined to be partitionable based on a determination that the ML operation includes at least one of a matrix multiplication operation or a matrix convolution operation, wherein said evaluating includes determining that the first sub-operation is associated with a first operational requirement and that the second sub-operation is associated with a second operational requirement, the first operational requirement being higher than the second operational requirement, and wherein said evaluating further includes (i) identifying that, as a result of the second operational requirement being lower than the first operational requirement, different data precision representations are usable for the first and second sub-operations and (ii) identifying that both the first and second sub-operations are simultaneously executable using the different data precision representations while satisfying a hardware utilization threshold of the set of hardware resources; in response to said evaluating: partitioning the ML operation into the first sub-operation and the second sub-operation; assigning the first sub-operation to use a first data precision representation to satisfy the first operational requirement; and assigning the second sub-operation to use a second data precision representation to satisfy the second operational requirement; causing a first kernel to execute the first sub-operation using the set of hardware resources and using the first data precision representation; concurrently with execution of the first kernel, causing a second kernel to execute the second sub-operation using the set of hardware resources and using the second data precision representation; obtaining a first result produced by the first kernel from executing the first sub-operation; obtaining a second result produced by the second kernel from executing the second sub-operation; dequantizing the second result into a dequantized second result by converting the second result from being represented in the second precision data representation to being represented in the first data precision representation; and combining the dequantized second result with the first result to produce a finalized result for the ML operation, wherein a characteristic of the finalized result satisfies an overall operational requirement associated with the ML operation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture for generating a fine-grained mixed precision quantized model.

FIG. 2 illustrates an example process flow for generating the fine-grained mixed precision quantized model.

FIGS. 3A, 3B, and 3C provide various illustrations on how different operations can be performed using different techniques.

FIG. 4 illustrates an example scenario in which certain hardware resources are being underutilized.

FIG. 5 provides various illustrations on how different operations can be performed using different techniques.

FIG. 6 illustrates an example process for partitioning a high-level problem or high-level operation into multiple sub-operations.

FIGS. 7A and 7B illustrate different techniques for customizing a kernel.

FIG. 8 illustrates an example graph depicting various performance metrics.

FIG. 9 illustrates a flowchart of an example method for generating the fine-grained mixed precision quantized model.

FIG. 10 illustrates another flowchart of an example method for generating the fine-grained mixed precision quantized model.

FIG. 11 illustrates an example computing system that can be configured to perform any of the disclosed operations.

### DETAILED DESCRIPTION

The disclosed embodiments beneficially relate to techniques for performing fine-grained mixed precision quantization for machine learning models. These techniques aim to maximize the hardware resource utilization and to improve the accuracy and hardware performance of the models during machine learning inference operations. Generally, the disclosed techniques involve fine-grained partitioning of high-level operations (e.g., matrix multiplication, convolution, etc.) into different precision data format (e.g., floating point data formats, integer data formats, char data formats, double data formats, etc.) sub-operations. The techniques further include the generation of custom kernels that are crafted to execute the sub-operations simultaneously on the hardware. The techniques can also utilize sorting and binning approaches to assign weights to different precision formats based on their importance for accuracy.

By performing the disclosed operations, significant benefits, advantages, and practical applications can be realized in the technical field of machine learning. In particular, the embodiments are able to significantly improve how efficiently hardware resources are being utilized. Whereas previous machine learning operations often left resources unused or underused for significant periods of time, the disclosed embodiments are able to strategically and intelligently order workflows so as to more fully capitalize the resources that are available. Additionally, the embodiments can improve the accuracy and precision by which the machine learning models operate.

Fine-grained quantization can help in deployment of large machine learning with minimal compute and memory capacity requirements while not trading off accuracy. Unlike the state-of-the-art coarse grained quantization techniques, fine-grained quantization results in negligible accuracy loss. This will help machine learning products to enable the inference of large models at lower compute costs, thus enabling lower service latencies and the capability to deploy large models on edge devices. Accordingly, these and numerous other benefits will now be described in more detail throughout the remaining portions of this disclosure.

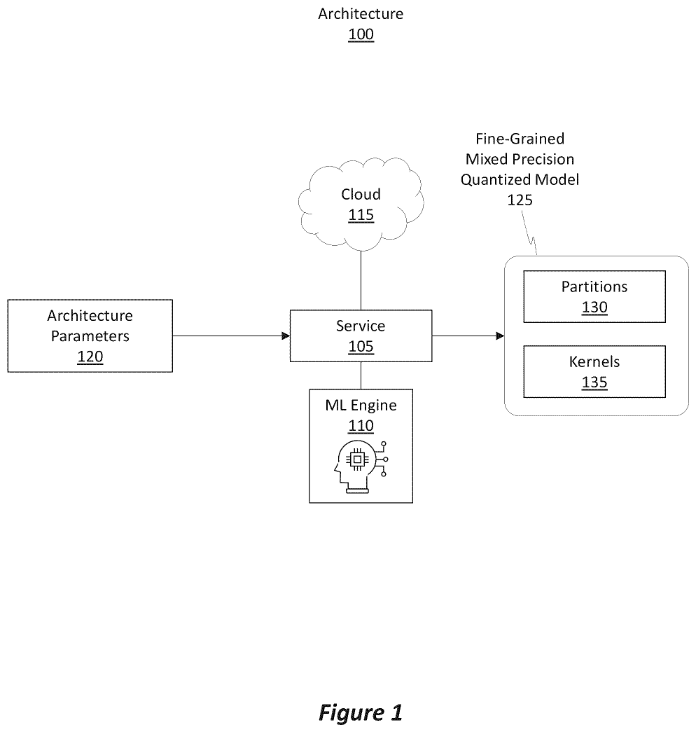

Having just described some of the high level benefits, advantages, and practical applications achieved by the disclosed embodiments, attention will now be directed to FIG. 1, which illustrates an example computing architecture 100 that can be used to achieve those benefits.

Architecture 100 includes a service 105, which can be implemented by any type of computing device. As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 110. The ML engine 110 enables the service 105 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 115 environment. In some implementations, service 105 is a local service operating on a local device. In some implementations, service 105 is a hybrid service that includes a cloud component operating in the cloud 115 and a local component operating on a local device. These two components can communicate with one another.

Generally, service 105 is tasked with accessing various architecture parameters 120 and then using those parameters 120 to generate a fine-grained mixed precision quantized model 125. This model 125 includes various partitions 130 that have been generated in an intelligent manner and further includes various customized kernels 135 that can operate on the partitions 130.

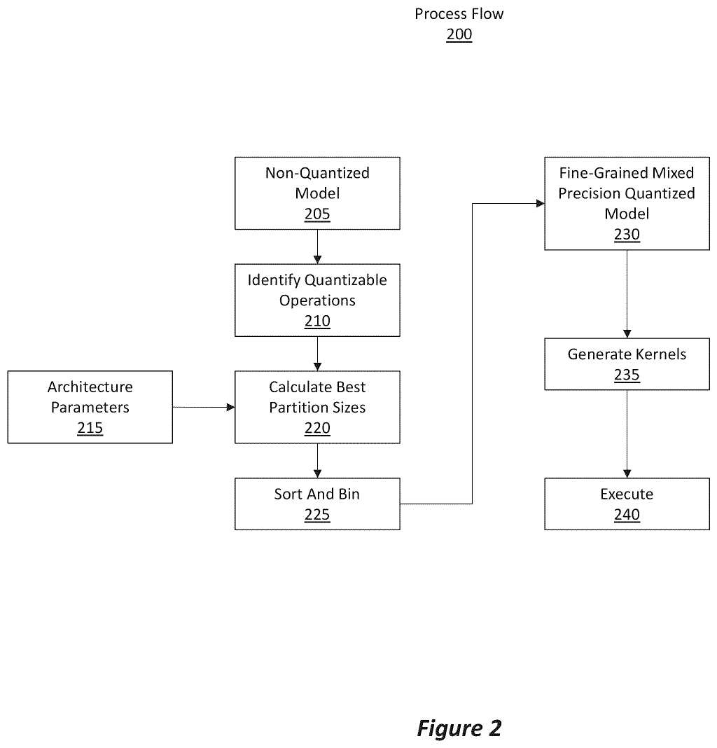

FIG. 2 provides some further clarification regarding the operations of service 105. At a high level, service 105 is tasked with performing the process flow 200 of FIG. 2. Initially, service 105 accesses a non-quantized model (act 205). Service 105 then identifies quantizable operations (act 210), such as a matrix multiplication or a convolution operation.

Service 105 also accesses architecture parameters 215, which correspond to the architecture parameters 120 of FIG. 1. Service 105 uses those parameters to then calculate the best partition sizes (act 220). In act 225, service 105 performs a sorting and binning operation, resulting in the generation of a fine-grained mixed precision quantized model 230. Service 105 also generates (act 235) customized kernels that then execute (act 240) code to achieve improved quantization.

The above description provided a high-level overview of some of the operations that can be achieved using architecture 100 of FIG. 1 and using service 105. Further details will now be provided.

In particular, service 105 is able to craft fine-grained mixed precision kernels for improving the hardware resource utilization. Doing so thereby improves hardware performance and regains accuracy lost in the quantization process of ML models.

Beneficially, the embodiments relate to the development of drop-in replacements for the implementation of certain operations (e.g., matrix multiplication, convolution, etc.). Notably, these drop-in replacements are configured to utilize more than one data format for their respective elements. The embodiments are able to leverage more than a single ALU pipeline in the hardware. Doing so significantly improves the hardware utilization by doing one or both of the following: (i) adding more columns/rows (to a matrix) of another precision with lower additional cost than adding columns/rows of the same precision (even when adding higher precision data) or (ii) replacing columns/rows by data in another precision reducing the overall latency (even when replacing it with higher precision data).

One beneficial result of implementing the disclosed principles is that the embodiments enable the development of a technique to perform mixed precision quantization within a single operation. Such a configuration is unlike the state-of-the-art technique of performing mixed precision quantization across multiple layers or multiple operations.

As a consequence, the embodiments improve the accuracy of the model compared to the normal quantized model at minimal additional cost to the latency or throughput of the inferencing system. The embodiments also improve the performance of a non-quantized model with negligible loss to accuracy while efficiently leveraging the underlying hardware.

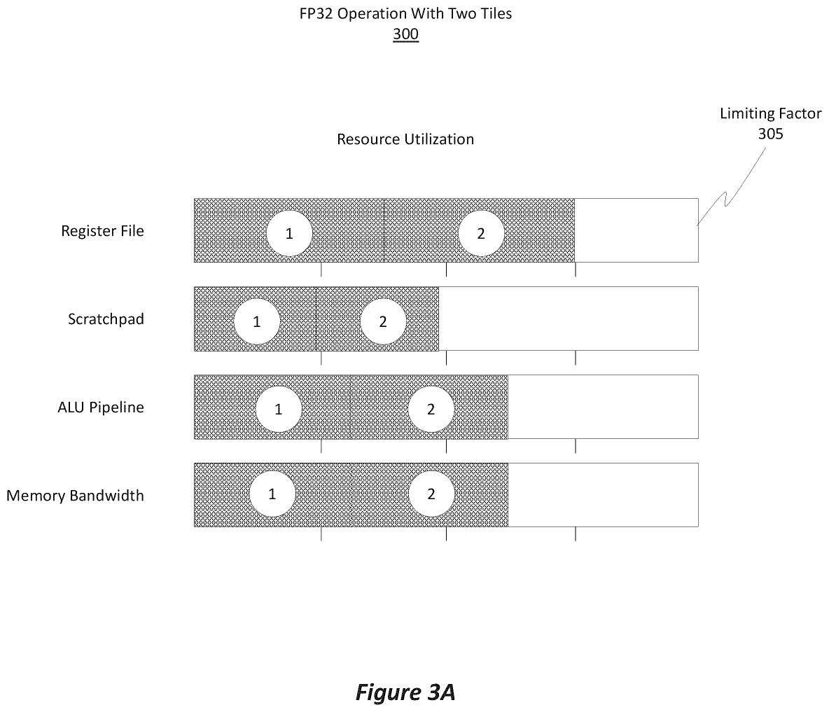

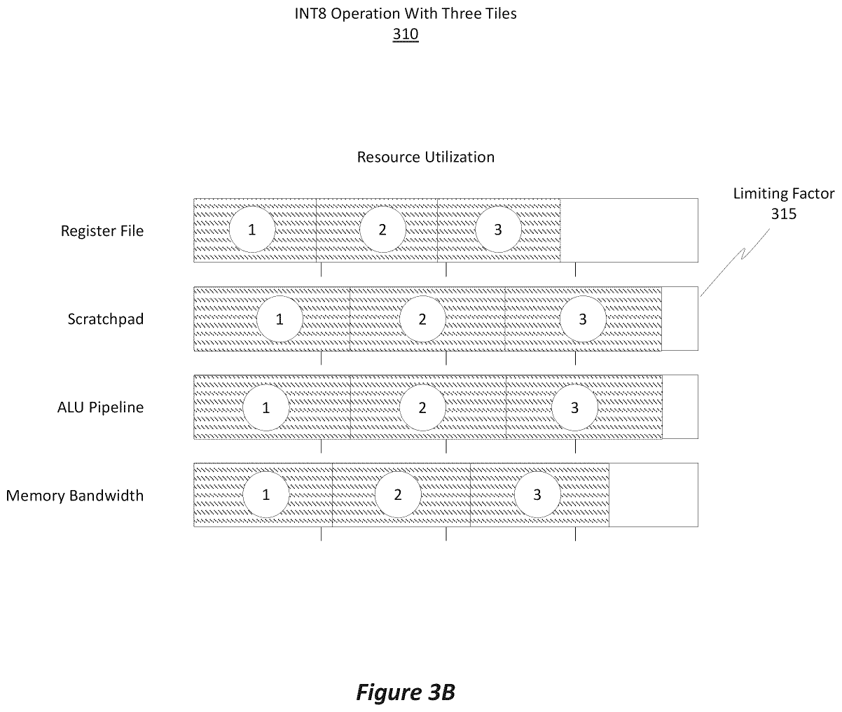

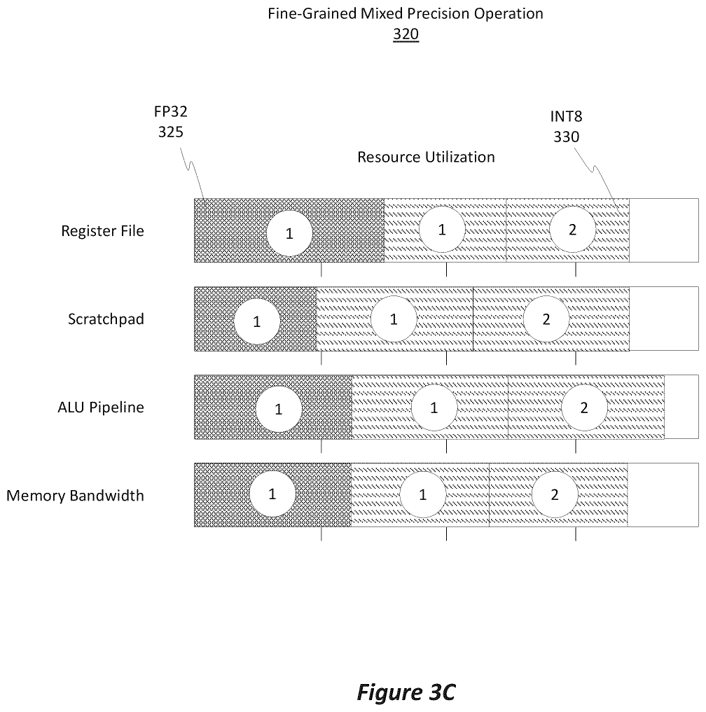

Although mixed-precision quantized models are state-of-art in inference deployment, these are typically quantized at a coarse-grain level of operations where one or more set of operations (such as matmul, convolution, etc.) are either quantized to lower precision or left non-quantized at higher-precision. However, this results in under-utilization of the register file, scratch pad, and ALU pipelines. For example, in a typical tiled execution of FP32/INT8 kernel, one of the hardware resources might be a limiting factor on a given core or set of cores, leading to underutilization as shown in FIGS. 3A and 3B.

In particular, FIG. 3A shows a scenario 300 involving an FP32 operation with two tiles (labeled 1 and 2). The tiled approach of execution on the hardware accelerators leads to underutilized hardware resource when the operation uses a single data format. For instance, in FIG. 3A, the register file is the limiting factor 305 and limits the utilization of the other resources. For example, the blank white spaces in the charts of FIG. 3A represent unutilized resources. Notice, the scratchpad, ALU pipeline, and the memory bandwidth all have significant portions of unutilized resources.

FIG. 3B is similar in its depiction. FIG. 3B shows a scenario 310 involving an INT8 operation with three tiles (labeled 1, 2, and 3). In FIG. 3B, the scratchpad is the limiting factor 315.

In contrast, the disclosed fine-grained mixed precision operation presented herein leads to maximization of hardware utilization, as shown in FIG. 3C. FIG. 3C shows a scenario 320 involving a fine-grained mixed precision operation in which tiles of different data formats (e.g., FP32 325 and INT8 330) can be operated on simultaneously in order to maximize the utilization of the hardware resources. Notice, the amount of white space in the charts (representing lack of hardware utilization) is significantly smaller in FIG. 3C as compared to FIGS. 3A and 3B.

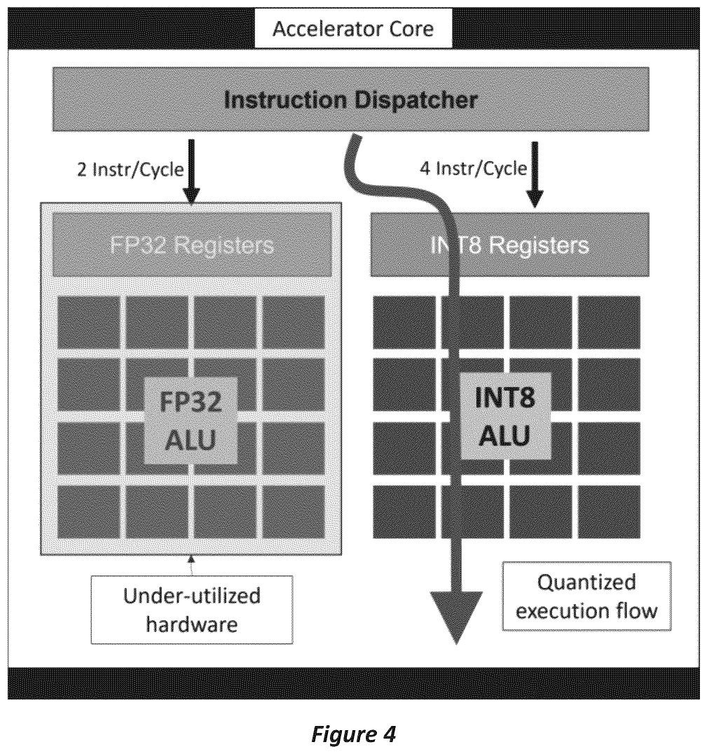

Another problem in certain hardware architectures is that the ALU units themselves are underutilized because of quantization. For example, the FP32 ALU units do not execute any instructions during the low-precision quantized operations/kernels, as shown in FIG. 4. This leads to the FP32 ALU units, registers, and the overall pipeline acting as dark silicon, thus leading to under-utilized hardware. The opposite happens during non-quantized operations where the lower precision ALU units are left under-utilized. Moreover, bubbles in the instruction dispatch streams may occur because memory and pipeline bottlenecks also lead to under-utilization. Thus, there is an opportunity to leverage these under-utilized pipelines and to perform meaningful computation within to either improve accuracy or performance (e.g., latency/throughput) of the models.

To achieve the above objectives, the disclosed embodiments craft fine-grained mixed precision kernels to improve the hardware resource utilization, thereby improving hardware performance and regaining accuracy lost in the quantization process of ML models.

That is, one function of the disclosed embodiments is to craft fine-grained mixed precision kernels that maximize hardware resource utilization. Another function of the disclosed embodiments is to divide a higher-level problem or operation (such as matrix multiplication, convolution, etc.) into multiple sub-problems or sub-operations of different precisions and to then execute those sub-problems/sub-operations simultaneously on a given piece of hardware using the crafted kernels.

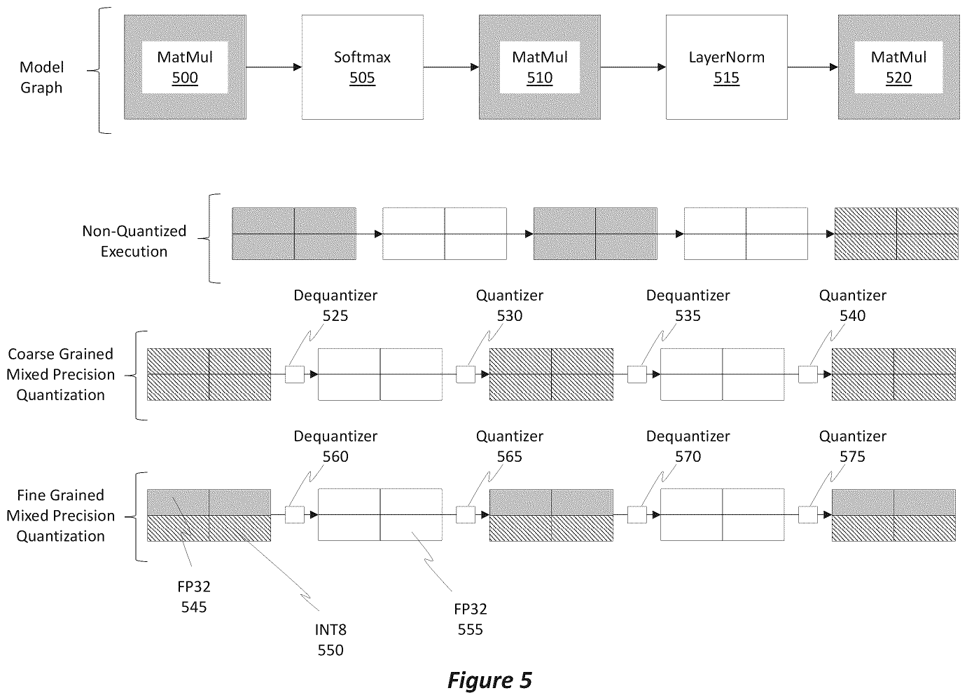

FIG. 5 shows an example of a model being executed on hardware using different execution flows. Each flow is represented in the form of a row of operations. In FIG. 5, there are four different execution flows.

The first execution flow (i.e. the first row) is that of a model graph. The second execution flow (i.e. the second row) is that of a non-quantized execution. The third execution flow (i.e. the third row) is that of a coarse-grained mixed precision quantized execution. The fourth execution flow (i.e. the fourth row) is the execution flow performed by the disclosed embodiments and includes a fine-grained mixed-precision quantized execution.

The model graph execution flow (i.e. the first row) includes a matrix multiplication operation (matmul 500), a softmax operation 505, a matmul operation 510, a layernorm operation 515, and a matmul operation 520. Notice, the color schemes used in FIG. 5. The white and gray color schemes represent use of an FP32 data precision format. The dashed lines gray represent use of an INT8 data precision format. Of course, these are examples of data formats, and other data formats can be used.

The non-quantized execution flow (i.e. the second row) includes similar operations (e.g., matmul, softmax, matmul, layernorm, and matmul). All of these operations are performed using a uniform data precision format (all using FP32 data precision formats).

The coarse-grained mixed precision quantized execution flow (i.e. the third row) includes similar operations (e.g., matmul, softmax, matmul, layernorm, and matmul). Notice, different data precision formats are now involved with these operations. Because different data precision formats are involved, various quantizers and dequantizers are now introduced into the pipeline, as will be discussed shortly.

The dashed lines in row three represent an INT8 data format, the gray and white coloring represents an FP32 data precision format. The first matmul operation is performed using INT8; the softmax is performed using FP32; the second matmul operation is performed using INT8; the layernorm is performed using FP32; and the last matmul operation is performed using INT8.

To alternate between these different data precision types, various quantizers and dequantizers are used throughout the execution flow. For instance, a dequantizer 525 converts the INT8 output of the first matmul operation into an FP32 data format. A quantizer 530 converts the FP32 output of the softmax operation into an INT8 data format. A dequantizer 535 converts the INT8 output of the second matmul operation into an FP32 data format. A quantizer 540 converts the FP32 output of the layernorm operation into an INT8 data format.

The fourth row execution flow (i.e. fine-grained mixed precision quantized execution) reflects the operations performed by the disclosed embodiments. The same operations are being performed as above.

Notice, for the first matmul operation, multiple data formats are being operated on, such as the FP32 format 545 and the INT8 format 550. The softmax operation is working on only data having the FP32 format, as shown by FP32 555. The second and third matmul operations, on the other hand, are working on multiple data formats. Similar to the earlier discussion, various dequantizers and quantizers are present to transform the data types, as shown by dequantizer 560, quantizer 565, dequantizer 570, and quantizer 575.

The coarse grained mixed precision quantized models (e.g., the third row execution flow) execute a single operation (such as Matmul) in a certain single data format, resulting in underutilization of hardware, as seen earlier in FIGS. 3A and 3B. FIG. 5 emphasizes the benefits of the fine-grained mixed-precision quantization technique compared to the other techniques. The disclosed fine-grained technique maximizes the utilization of hardware resources, thereby improving performance while delivering higher accuracy for ML models.

The fine-grained mixed-precision quantization involves dividing the operation (e.g., the matmul operation or the softmax operation or the layernorm operation, etc.) into multiple sub-problems/sub-operations and then executing them simultaneously on the hardware, thereby leveraging the resources efficiently.

The fine-grained mixed-precision quantization also includes the generation of custom kernels. The custom kernel generation happens using a number of distinct steps. One step involves identifying and calculating the best partitioning sizes (for each data format) for a given problem/operation size and for a given target hardware architecture. This step happens either during the quantization process in post-training quantization or as part of the quantization-aware training process.

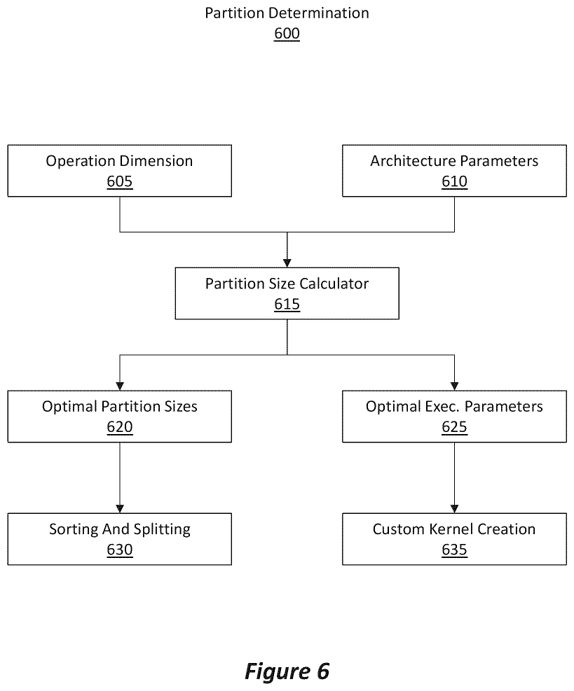

Stated differently, the first step in the fine-grained quantization flow (after identifying the quantizable operations) is to calculate the partition size as well as execution parameters needed for generating custom kernels. This would involve taking the operation's dimensions and the parameters of the underlying hardware architecture. FIG. 6 is representative.

FIG. 6 shows a partition determination 600 process. This process includes an act 605 of determining the operation's dimensions (e.g., the dimensions of the matrices that are being multiplied). The process also includes an act 610 of determining the architecture's parameters and an act 615 of utilizing a partition size calculator.

The calculator generates (act 620) optimal partition sizes and facilitates the generation (act 625) of determining the optimal execution parameters. The partitions can then be sorted and split or binned (act 630), and the embodiments can generate the custom kernels (act 635).

By way of further detail, operation dimensions include parameters such as the number of columns and rows of the weight matrix and activations in a matrix multiplication or general matrix multiply (GEMM) operation. These are sometimes referred to as M, N, and K. They are also called as input features and output features in machine learning. For other operations, such as a convolution operation, parameters such as kernel size, input channels, output channels, etc., can be considered. Additionally, deployment parameters such as batch size and sequence length may also matter depending on how the operation executes within the overall ML model architecture.

Parameters of hardware architecture are also relevant when identifying the optimal partitioning sizes. This process involves architectural features of the hardware such as the number of cores per stream multiprocessor (SM), operation frequency, number of ALU units of each precision, throughput of tensor unit, native dimension of tensor multiplication supported by tensor units, cache size, shared memory/scratchpad size, register file size, etc. These parameters are relevant when determining what would be the dimension of each precision that could be supported by the underlying hardware and when executing the mixed-precision kernel either using a custom kernel or by using multiple kernels simultaneously on the hardware.

These two sets of parameters are taken in by a model (e.g., the partition size calculator). This model is tasked with determining the optimal partitioning sizes as well as execution parameters, such as the shape of the tile that will execute on a single SM. An example will be helpful.

Assume a GPU hardware with 40 SMs and a tensor unit supporting 8×8×16 (M×N×K) are available. The native dimension of the tensor unit is INT8 and 16×16×8 (M×N×K) for FP16. Further, the embodiments identify a quantizable operation MatMul in a model with dimension 512×640×768 (M×N×K). The embodiments may split the MatMul operation along the K-dimension (768). In particular, the embodiments may split the MatMul into two sub-problems of INT8 and FP16 such that the tensors (matrices) would be split in 16:8 ratio (or 2:1) according to the native dimension of the tensor unit along the K-dimension.

Thus, the embodiments split the MatMul into two sub-problems: INT8 problem (512×640×512) and the FP16 problem (512×640×256). This would be used in the next step of sorting and binning the weights accordingly. Further, to utilize the overall SMs available in the hardware (40) efficiently, the embodiments tile the problems accordingly. In this case, the embodiments can create a tile shape of 64×128 (M×N) leading to 8×5 tiles, which results in a value of 40. This would be used to create the custom kernel(s) to be executed on the hardware during execution (inference or quantization-aware-training).

Note that there is an assumption that a simple model using only a subset of hardware parameters is used. The embodiments can use a larger set of hardware parameters to identify optimal partitioning sizes and execution parameters. Further, note that there is an assumption that a GPU architecture is available, but the embodiments are actually agnostic to the type of hardware architecture.

Moreover, this process is optimal when done offline during quantization process, but it can also be done online during inference, if needed. Finally, the partition sizes and execution parameter dimensions suggested by the calculator are just optimal suggestions and may not necessarily be followed by later steps of sorting or during the custom kernel creation.

The second step in the fine-grained quantization flow is to compute the custom kernels. Generating a custom kernel that tiles and executes the sub-operations on the underlying hardware can be done offline during compilation or online during runtime of the inference. The sub-operations can be crafted into kernels in a number of steps.

One step involves creating separate kernels with optimal tile sizes and then launching them both on the hardware simultaneously or concurrently (e.g., two time periods that at least partially overlap with one another), thereby ensuring that some or all the hardware resources on the hardware are shared between the kernels. Another step involves creating a fused kernel that computes both the sub-problems. This fused kernel executes code for two or more data formats and can then be launched on the hardware, thereby explicitly ensuring sharing of hardware resources efficiently.

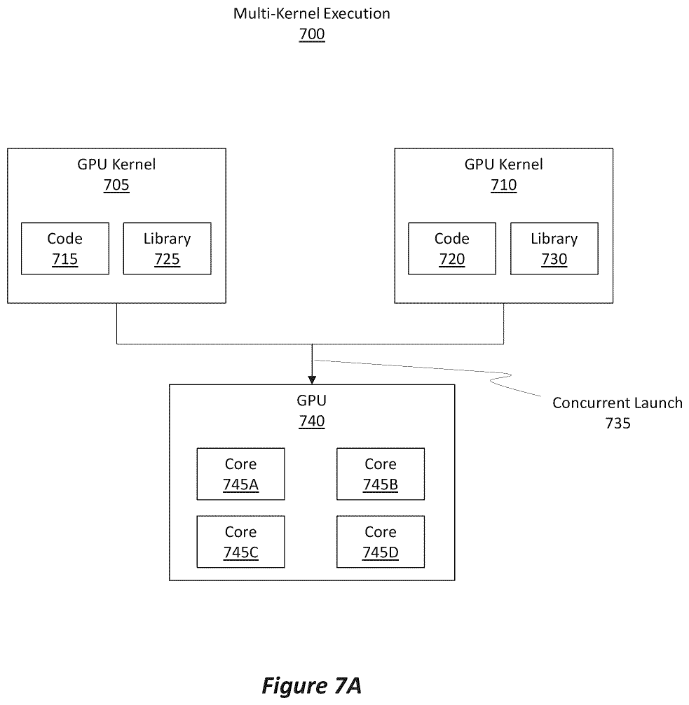

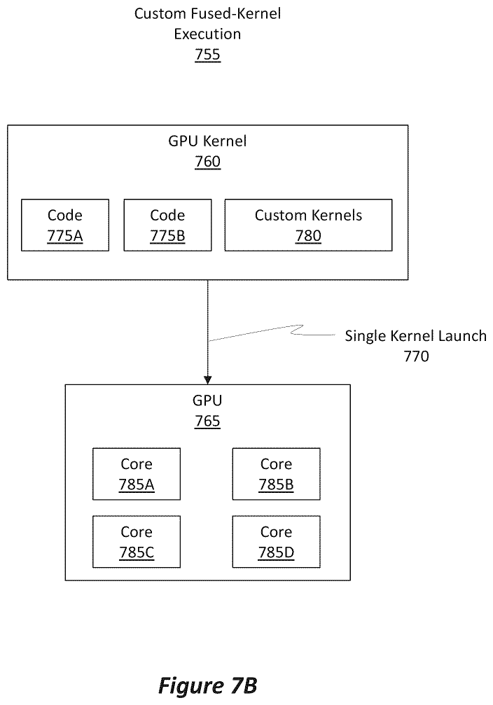

Executing the sub-problems on the underlying hardware requires orchestrating the code to compute the result. The generally available libraries currently do not support hybrid execution of operations such as matrix multiplication, convolution, etc., with more than one data format as the input. Thus, the disclosed embodiments present custom implementations of execution of the sub-operations. The custom kernel creation can be done by any one or both of the ways shown in FIGS. 7A and 7B.

FIG. 7A shows a multi-kernel execution scenario 700. The sub-operations can be individually considered as a single operation; thus each sub-operation is launched on the GPU simultaneously (e.g., as shown by GPU kernel 705 and GPU kernel 710). This can be done either by using concurrent execution semantics, such as CUDA streams. This means that the code for each kernel is programmed to solve any one individual sub-operation. Any post-processing that needs to be done would be programmed in a separate kernel or as epilogue of one of the sub-operations.

Program code (e.g., code 715 and code 720) from standard libraries (e.g., library 725 and library 730) may be leveraged for execution of each kernel. A concurrent execution framework (e.g., as shown by concurrent launch 735) is used to execute. The scheduling of the GPU kernels will rely on GPU lower-level libraries. The result is that the GPU 740 can use various different cores (e.g., cores 745A, 745B, 745C, and 745D) to execute.

FIG. 7B shows a scenario 755 involving a custom fused-kernel execution. Here, the sub-operations can be coded within a single kernel (e.g., GPU kernel 760) and launched on the GPU 765, as shown by single kernel launch 770. This means that the code (e.g., code 775A and 775B) for sub-operations is fused into a single GPU kernel program (e.g., as shown by customer kernels 780). However, the sub-operations can then either be executed on different cores (e.g., cores 785A, 785B, 785C, and 785D) within the GPU, different blocks of threads (or warps) within a core, or different instructions within a block. Custom code (e.g., code 775A and 775B) is programmed to execute the sub-operations. However, it is not necessary that all cores execute all the sub-operations. The parallel code can be instrumented to be executed according to the requirements as stated above. A standard execution framework of launching single GPU kernels can then be leveraged.

Accordingly, the fine-grained quantization flow can operate in the following manner. The embodiments identify the sizes of partitions that a given high-level problem/operation must be split into. The embodiments sort weights within a given operation according to their need for higher precision to deliver higher accuracy. The embodiments bin the weights to each precision format according to the proportions identified in the earlier operation (e.g., the identification of the partition sizes). The embodiments then compile the mixed-precision quantized kernel and then leverage the underlying hardware resources efficiently.

In this regard, the embodiments present various techniques for utilizing custom kernels to gain hardware performance in addition to regaining accuracy loss. This innovation utilizes the underlying hardware architecture to identify ideal sub-operation sizes and to generate the custom kernels. The ideal partition size may be different for any given operation size and underlying architecture.

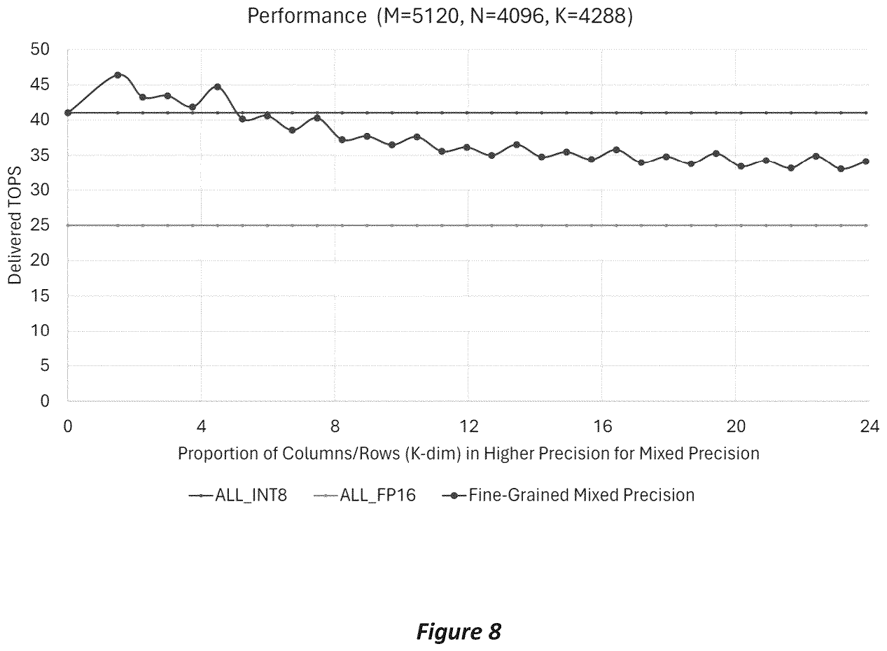

FIG. 8 illustrates the execution latency of a GEMM problem partitioned into FP16 and INT8 sub problems in different proportions (x-axis). The custom kernel generated at 4.4% FP16/95.6% INT8 delivers 9% improved performance compared to 100% INT8, and there is an expectation of regaining all of the accuracy with the calibration dataset for a large language model (LLM).

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

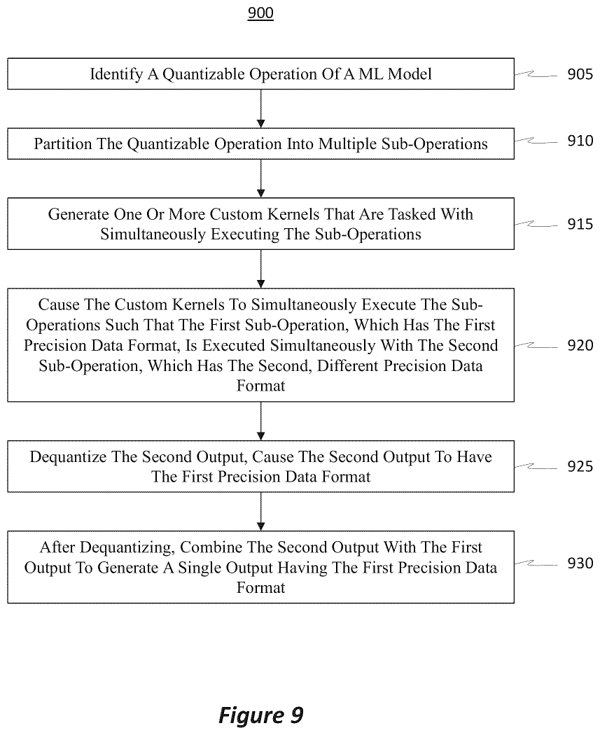

Attention will now be directed to FIG. 9, which illustrates a flowchart of an example method 900 for performing fine-grained mixed precision quantization for a machine learning (ML) model. This model, using this quantization, attempts to maximize hardware resource utilization during an inference performed by the ML model. Stated differently, the embodiments rely on the quantization to utilize hardware resources during the inference process. Method 900 can be implemented within the architecture 100 of FIG. 1; further, method 900 can be performed by service 105.

Method 900 includes an act (act 905) of identifying a quantizable operation of a machine learning (ML) model. This identification is performed based on a determination that the quantizable operation is one that is to be operated on using the ML model. Optionally, the quantizable operation may be a matrix multiplication operation or a convolution operation.

Act 910 includes partitioning the quantizable operation into a plurality of sub-operations having multiple different precision data formats. A first sub-problem included in the sub-problems has a first precision data format, and a second sub-problem included in the sub-problems has a second, different precision data format. Therefore, as indicated above, the plurality of sub-operations have multiple different precision data formats. Optionally, the first precision data format is one of a floating point data format (e.g., FP8, FP16, FP32, FP64, etc.), a char data format, an integer data format (e.g., INT8, INT16, INT32, etc.), or a double data format. The second, different precision data format can also be one of a floating point data format, a char data format, an integer data format, or a double data format.

In some implementations, each sub-operation in the plurality of sub-operations is assigned a weight according to its respective need for precision (e.g., according to a determined precision requirement). The weights assigned to the plurality of sub-operations can then be binned to each precision data format. Optionally, the embodiments can be agnostic with respect to the exact process of weight assignment.

In some implementations, sizes of the plurality of sub-operations are determined as a part of the partitioning process. The sizes can be set based on a dimension of the quantizable operation. Optionally, the sizes can be further set based on hardware capability parameters.

Act 915 includes generating one or more kernels, which may be custom kernels, that are tasked with simultaneously executing the plurality of sub-operations. In some implementations, the one or more kernels include a plurality of kernels with a respective kernel assigned to each sub-operation included in the plurality of sub-operations. In some other implementations, the one or more kernels include a single fused kernel that executes the plurality of sub-operations.

Act 920 includes causing the one or more kernels to simultaneously execute the plurality of sub-operations. Consequently, the first sub-problem, which has the first precision data format, is executed simultaneously with the second sub-problem, which has the second, different precision data format.

Act 925 includes dequantizing the second output, causing the second output to have the first precision data format. After dequantizing, act 930 includes combining the second output with the first output to generate a single output having the first precision data format.

Stated differently, after the one or more kernels simultaneously execute the plurality of sub-operations, a result is produced. The result comprises a first portion of data having the first precision data format and a second portion of data having a second precision data format. A dequantization operation may then be performed only on the second portion of data to cause the second portion of data to have the first precision data format.

That is, in some scenarios, only a portion, not an entirety, of an output that is generated from simultaneously executing the plurality of sub-operations is subsequently subjected to the dequantization operation. In some cases, the output that is generated from simultaneously executing the plurality of sub-operations includes a first portion having an FP32 precision data format and a second portion having an INT8 precision data format. In some cases, the second portion having the INT8 precision data format is subsequently subjected to a dequantization operation to transform the second portion to having the FP32 precision data format. After the transformation, the second portion is combined with the first portion to generate a single output having the FP32 precision data format.

Accordingly, the disclosed embodiments are directed to fine-grained mixed-precision quantization for machine learning models so as to maximize hardware resource utilization and to improve accuracy of models. The embodiments can partition operations such as matrix multiplication, convolution, and other operations into different precision data formats. The embodiments also craft custom kernels that execute all the partitioned subproblems simultaneously on a device, resulting in efficient utilization of hardware. A sorting and binning approach ensures that accuracy of the model is retained compared to a non-quantized model. The custom fine-grained kernels also ensure higher hardware performance.

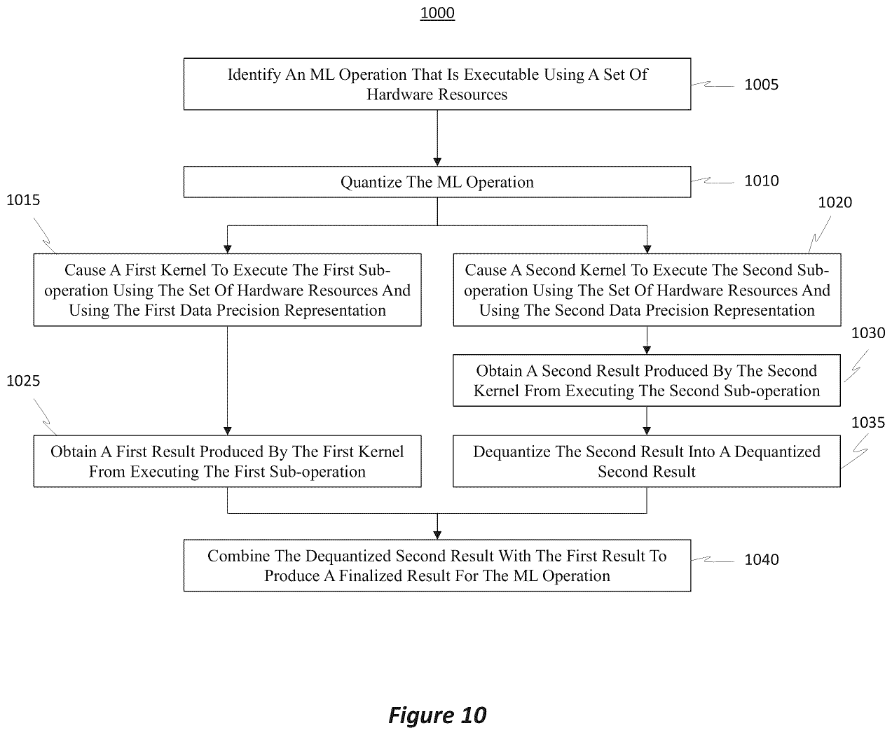

FIG. 10 shows a flowchart of an example method 1000 that may also be implemented within architecture 100 of FIG. 1 and by service 105. Method 1000 is a method for facilitating execution of an ML operation by determining that the ML operation is partitionable into multiple sub-operations having different operational requirements, which include one or more of an accuracy requirement, a latency requirement, or a throughput requirement for an ML model executing the ML operation, and by executing the multiple sub-operations using different data precision representations to satisfy the different accuracy requirements while also satisfying a predetermined hardware utilization threshold.

Method 1000 includes an act (act 1005) of identifying an ML operation that is executable using a set of hardware resources. Act 1010 then includes quantizing the ML operation by performing a number of operations.

One of the quantization operations includes evaluating the ML operation to determine that the ML operation is partitionable into at least a first sub-operation and a second sub-operation. The ML operation is determined to be partitionable based on a determination that the ML operation includes at least one of a matrix multiplication operation or a matrix convolution operation. The process of evaluating includes determining that the first sub-operation is associated with a first operational requirement and that the second sub-operation is associated with a second operational requirement. The first operational requirement is higher than the second operational requirement.

In some cases, the first operational requirement is a first accuracy requirement in which the first result produced by a certain kernel (e.g., the later described “first” kernel) executing the first sub-operation is within a threshold value relative to a value obtained from training data used to train an ML model performing the ML operation. In other words, the training data can be used as a baseline truth or standard for determining accuracy. As one example, the output produced by the ML model may be required to be within a 95% level of closeness or similarity to that of the training data. Of course, other percentages can be used. By “closeness,” it is generally meant that the relative degree of similarity between two sets of data satisfies some threshold. For instance (using a simplistic example), if a first data set includes the values A, B, C, and D, and a second data set includes the values A, B, C, and E, it might be the case that these two data sets have a 75% degree of relative similarity because three out of the four values are the same.

In some cases, the first operational requirement is a first performance requirement in which a latency metric for an ML model performing the ML operation satisfies a latency threshold. The latency metric outlines the amount of time the ML model takes to perform its computations. The latency threshold can be a maximum amount of time that is permitted for the ML model to operate. Optionally, the first operational requirement may be a first performance requirement in which a throughput metric for an ML model performing the ML operation satisfies a throughout threshold. The throughput metric may reflect the number of operations or computations that are performed by the ML model. The throughput threshold can thus be a desired amount of operations or computations that the ML model is to perform within a given timespan.

The evaluating further includes (i) identifying that, as a result of the second operational requirement being lower than the first operational requirement, different data precision representations are usable for the first and second sub-operations and (ii) identifying that both the first and second sub-operations are simultaneously executable using the different data precision representations while satisfying a hardware utilization threshold of the set of hardware resources. In some cases, the hardware utilization threshold is a minimum amount of the set of hardware resources that are left unused during execution of certain kernels (e.g., the first and second kernels described later).

In response to that evaluation, another quantization operation includes partitioning the ML operation into the first sub-operation and the second sub-operation. Another quantization operation includes assigning the first sub-operation to use a first data precision representation to satisfy the first operational requirement. Another quantization operation includes assigning the second sub-operation to use a second data precision representation to satisfy the second operational requirement. In some cases, the first data precision representation is one of a floating point data format, a char data format, an integer data format, or a double data format. In some cases, the second data precision representation is a different one of the floating point data format, the char data format, the integer data format, or the double data format.

Act 1015 includes causing a first kernel to execute the first sub-operation using the set of hardware resources and using the first data precision representation. Concurrently with execution of the first kernel, act 1020 includes causing a second kernel to execute the second sub-operation using the set of hardware resources and using the second data precision representation.

Act 1025 includes obtaining a first result produced by the first kernel from executing the first sub-operation. Similarly, act 1030 includes obtaining a second result produced by the second kernel from executing the second sub-operation. Act 1035 includes dequantizing the second result into a dequantized second result. This dequantization is performed by converting the second result from being represented in the second precision data representation to being represented in the first data precision representation.

Act 1040 then includes combining the dequantized second result with the first result. This combination act produces a finalized result for the ML operation. Notably, a characteristic of the finalized result satisfies an overall operational requirement associated with the ML operation. The overall operational requirement may be one of an accuracy requirement or a performance requirement, as described earlier. For instance, the performance requirement may be a latency requirement for an ML model performing the ML operation. The performance requirement may be a throughput requirement for an ML model performing the ML operation.

In some cases, the first or second kernel is a graphics processing unit (GPU) kernel. Relatedly, in some cases, a schedule for the first or second kernel is based on a graphics processing unit (GPU) lower-level library. Also, in some embodiments, at least some of the set of hardware resources are shared between the first kernel and the second kernel.

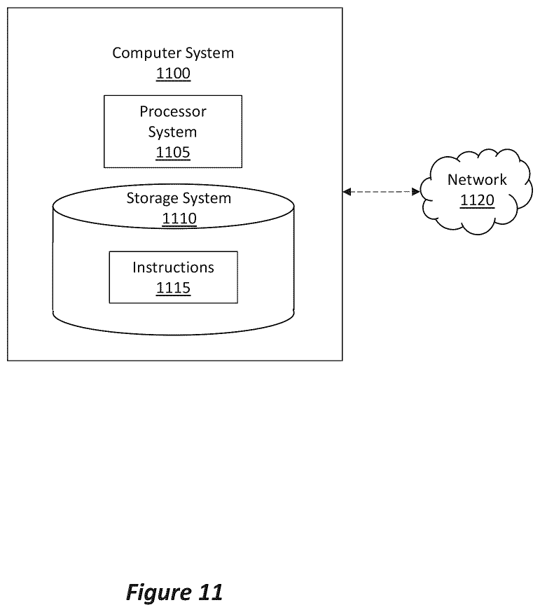

Attention will now be directed to FIG. 11 which illustrates an example computer system 1100 that may include and/or be used to perform any of the operations described herein. For instance, computer system 1100 can implement service 105 of FIG. 1.

Computer system 1100 may take various different forms. For example, computer system 1100 may be embodied as a tablet, a desktop, a laptop, a mobile device, or a standalone device, such as those described throughout this disclosure. Computer system 1100 may also be a distributed system that includes one or more connected computing components/devices that are in communication with computer system 1100.

In its most basic configuration, computer system 1100 includes various different components. FIG. 11 shows that computer system 1100 includes a processor system 1105 comprising one or more processor(s) (aka a “hardware processing unit”) and a storage system 1110.

Regarding the processor(s) of the processor system 1105, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 1100. The different components, modules, engines, and services described herein may be implemented as objects or processors that execute on computer system 1100 (e.g., as separate threads).

Storage system 1110 may be physical system memory, which may be volatile, non-volatile, or some combination of the two. The term “memory” may also be used herein to refer to non-volatile mass storage such as physical storage media. If computer system 1100 is distributed, the processing, memory, and/or storage capability may be distributed as well.

Storage system 1110 is shown as including executable instructions 1115. The executable instructions 1115 represent instructions that are executable by the processor(s) of the processor system 1105 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1100 may also be connected (via a wired or wireless connection) to external sensors (e.g., one or more remote cameras) or devices via a network 1120. For example, computer system 1100 can communicate with any number devices or cloud services to obtain or process data. In some cases, network 1120 may itself be a cloud network. Furthermore, computer system 1100 may also be connected through one or more wired or wireless networks to remote/separate computer systems(s) that are configured to perform any of the processing described with regard to computer system 1100.

A “network,” like network 1120, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1100 will include one or more communication channels that are used to communicate with the network 1120. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g., cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for facilitating execution of a machine learning (ML) operation by determining that the ML operation is partitionable into multiple sub-operations having different operational requirements, the operational requirements including one or more of an accuracy requirement, a latency requirement, or a throughput requirement for an ML model executing the ML operation, and by executing the multiple sub-operations using different data precision representations to satisfy the different operational requirements while also satisfying a predetermined hardware utilization threshold, said method comprising:
identifying an ML operation that is executable using a set of hardware resources;
quantizing the ML operation by:
evaluating the ML operation to determine that the ML operation is partitionable into at least a first sub-operation and a second sub-operation, wherein the ML operation is determined to be partitionable based on a determination that the ML operation includes at least one of a matrix multiplication operation or a matrix convolution operation, wherein said evaluating includes determining that the first sub-operation is associated with a first operational requirement and that the second sub-operation is associated with a second operational requirement, the first operational requirement being higher than the second operational requirement, and wherein said evaluating further includes (i) identifying that, as a result of the second operational requirement being lower than the first operational requirement, different data precision representations are usable for the first and second sub-operations and (ii) identifying that both the first and second sub-operations are simultaneously executable using the different data precision representations while satisfying a hardware utilization threshold of the set of hardware resources;
in response to said evaluating:
partitioning the ML operation into the first sub-operation and the second sub-operation;
assigning the first sub-operation to use a first data precision representation to satisfy the first operational requirement; and
assigning the second sub-operation to use a second data precision representation to satisfy the second operational requirement;
causing a first kernel to execute the first sub-operation using the set of hardware resources and using the first data precision representation;
concurrently with execution of the first kernel, causing a second kernel to execute the second sub-operation using the set of hardware resources and using the second data precision representation;
obtaining a first result produced by the first kernel from executing the first sub-operation;
obtaining a second result produced by the second kernel from executing the second sub-operation;
dequantizing the second result into a dequantized second result by converting the second result from being represented in the second precision data representation to being represented in the first data precision representation; and
combining the dequantized second result with the first result to produce a finalized result for the ML operation, wherein a characteristic of the finalized result satisfies an overall operational requirement associated with the ML operation.

2. The method of claim 1, wherein the first operational requirement is a first accuracy requirement in which the first result produced by the first kernel executing the first sub-operation is within a threshold value relative to a value obtained from training data used to train the ML model performing the ML operation.

3. The method of claim 1, wherein the first operational requirement is a first performance requirement in which a latency metric for the ML model performing the ML operation satisfies a latency threshold.

4. The method of claim 1, wherein the first operational requirement is a first performance requirement in which a throughput metric for the ML model performing the ML operation satisfies a throughout threshold.

5. The method of claim 1, wherein the hardware utilization threshold is a minimum amount of the set of hardware resources that are left unused during execution of the first and second kernels.

6. The method of claim 1, wherein the first data precision representation is one of a floating point data format, a char data format, an integer data format, or a double data format.

7. The method of claim 6, wherein the second data precision representation is a different one of the floating point data format, the char data format, the integer data format, or the double data format.

8. The method of claim 1, wherein the ML operation is the matrix multiplication operation.

9. The method of claim 1, wherein the ML operation is the matrix convolution operation.

10. The method of claim 1, wherein the set of hardware resources includes a register file, a scratch pad space, an arithmetic logic unit (ALU) compute unit, and a memory.

11. A computer system comprising:
a processor system; and
a storage system that stores instructions that are executable by the processor system to cause the computer system to:
identify an ML operation that is executable using a set of hardware resources;
quantize the ML operation by:
evaluating the ML operation to determine that the ML operation is partitionable into at least a first sub-operation and a second sub-operation, wherein the ML operation is determined to be partitionable based on a determination that the ML operation includes at least one of a matrix multiplication operation or a matrix convolution operation, wherein said evaluating includes determining that the first sub-operation is associated with a first operational requirement and that the second sub-operation is associated with a second operational requirement, the first operational requirement being higher than the second operational requirement, and wherein said evaluating further includes (i) identifying that, as a result of the second operational requirement being lower than the first operational requirement, different data precision representations are usable for the first and second sub-operations and (ii) identifying that both the first and second sub-operations are simultaneously executable using the different data precision representations while satisfying a hardware utilization threshold of the set of hardware resources;
in response to said evaluating:
partitioning the ML operation into the first sub-operation and the second sub-operation;
assigning the first sub-operation to use a first data precision representation to satisfy the first operational requirement; and
assigning the second sub-operation to use a second data precision representation to satisfy the second operational requirement;
cause a first kernel to execute the first sub-operation using the set of hardware resources and using the first data precision representation;
concurrently with execution of the first kernel, cause a second kernel to execute the second sub-operation using the set of hardware resources and using the second data precision representation;
obtain a first result produced by the first kernel from executing the first sub-operation;
obtain a second result produced by the second kernel from executing the second sub-operation;
dequantize the second result into a dequantized second result by converting the second result from being represented in the second precision data representation to being represented in the first data precision representation; and
combine the dequantized second result with the first result to produce a finalized result for the ML operation, wherein a characteristic of the finalized result satisfies an overall operational requirement associated with the ML operation.

12. The computer system of claim 11, wherein the first data precision representation of the dequantized second result is one of a floating point data format, a char data format, an integer data format, or a double data format.

13. The computer system of claim 11, wherein the overall operational requirement is one of an accuracy requirement or a performance requirement.

14. The computer system of claim 13, wherein the performance requirement is a latency requirement for the ML model performing the ML operation.

15. The computer system of claim 13, wherein the performance requirement is a throughput requirement for the ML model performing the ML operation.

16. The computer system of claim 11, wherein the first kernel is a graphics processing unit (GPU) kernel.

17. The computer system of claim 11, wherein a schedule for the first kernel is based on a graphics processing unit (GPU) lower-level library.

18. The computer system of claim 11, wherein at least some of the set of hardware resources are shared between the first kernel and the second kernel.

19. The computer system of claim 18, wherein the set of hardware resources includes a register file, a scratch pad space, an arithmetic logic unit (ALU) compute unit, and a memory.

20. One or more hardware storage devices that store instructions that are executable by one or more processors to cause the one or more processors to:
identify an ML operation that is executable using a set of hardware resources;
quantize the ML operation by:
evaluating the ML operation to determine that the ML operation is partitionable into at least a first sub-operation and a second sub-operation, wherein the ML operation is determined to be partitionable based on a determination that the ML operation includes at least one of a matrix multiplication operation or a matrix convolution operation, wherein said evaluating includes determining that the first sub-operation is associated with a first operational requirement and that the second sub-operation is associated with a second operational requirement, the first operational requirement being higher than the second operational requirement, and wherein said evaluating further includes (i) identifying that, as a result of the second operational requirement being lower than the first operational requirement, different data precision representations are usable for the first and second sub-operations and (ii) identifying that both the first and second sub-operations are simultaneously executable using the different data precision representations while satisfying a hardware utilization threshold of the set of hardware resources;
in response to said evaluating:
partitioning the ML operation into the first sub-operation and the second sub-operation;
assigning the first sub-operation to use a first data precision representation to satisfy the first operational requirement; and
assigning the second sub-operation to use a second data precision representation to satisfy the second operational requirement;
cause a first kernel to execute the first sub-operation using the set of hardware resources and using the first data precision representation;
concurrently with execution of the first kernel, cause a second kernel to execute the second sub-operation using the set of hardware resources and using the second data precision representation;
obtain a first result produced by the first kernel from executing the first sub-operation;
obtain a second result produced by the second kernel from executing the second sub-operation;
dequantize the second result into a dequantized second result by converting the second result from being represented in the second precision data representation to being represented in the first data precision representation; and
combine the dequantized second result with the first result to produce a finalized result for the ML operation, wherein a characteristic of the finalized result satisfies an overall operational requirement associated with the ML operation.
